(19) United States
(12) Patent Application Publication
(10) Pub. No.: US 2026/0157277 A1
(43) Pub. Date: Jun. 11, 2026

(54) SYSTEMS AND METHODS FOR SETTING BOUNDARIES FOR A REEL OF AN AGRICULTURAL HEADER

(71) Applicant: CNH Industrial America LLC, New Holland, PA (US)

(72) Inventors: Cory Douglas Hunt, II, Millersville, PA (US); Jethro Martin, Ephrata, PA (US)

(21) Appl. No.: 18/654,086

(22) PCT Filed: Nov. 4, 2022
(86) PCT No.: PCT/US2022/049058

§ 371 Date: May 3, 2024

Related U.S. Application Data
(60) Provisional application No. 63/276,277, filed on Nov. 5, 2021.

(51) Int. Cl. A01D 41/14; A01D 41/127; A01D 57/04

(52) U.S. Cl. CPC A01D 41/141; A01D 41/127; A01D 57/04

(57) ABSTRACT

An agricultural system includes a frame, a cutter bar assembly configured to cut crops during an operation of the agricultural system, and a reel configured to guide the crops toward the cutter bar assembly and to move relative to the frame during the operation of the agricultural system. The agricultural system also includes a controller configured to receive sensor feedback indicative of occurrences of the reel being in an undesirable position relative to the cutter bar assembly, receive additional sensor feedback indicative of positions of the reel during the occurrences, generate one or more boundaries for the reel based on the positions of the reel during the occurrences, and provide an output based on the one or more boundaries.

### BACKGROUND

The present disclosure relates generally to systems and methods for setting boundaries for a reel of an agricultural header.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

A harvester may be used to harvest crops, such as barley, beans, beets, carrots, corn, cotton, flax, oats, potatoes, rye, soybeans, wheat, or other plants. A harvesting process may begin by operating a header of the harvester to remove a portion of a plant from a field. In some cases, the header may cut the plant to form cut crops and transport the cut crops to a processing system of the harvester.

Certain headers include a cutter bar assembly configured to cut a portion of each plant (e.g., a stalk), thereby separating the cut crops from the soil. The cutter bar assembly may extend along a substantial portion of a width of the header at a forward end of the header. The header may also include one or more belts positioned behind the cutter bar assembly relative to a direction of travel of the harvester. The belt(s) are configured to transport the cut crops to an inlet of the processing system.

Certain headers may also include a reel, which may include a reel member having multiple fingers extending from a central framework. The central framework is driven to rotate, such that the fingers move in a circular pattern. The fingers are configured to engage the plants, thereby preparing the plants to be cut by the cutter bar assembly and/or urging the cut crops to move toward the belt(s). The reel member is typically supported by multiple arms extending from a frame of the header. The reel may include one or more actuators configured to drive the multiple arms to rotate, thereby adjusting a position of the reel relative to the frame of the header.

### SUMMARY

Certain embodiments commensurate in scope with the originally claimed subject matter are summarized below. These embodiments are not intended to limit the scope of the claimed subject matter, but rather these embodiments are intended only to provide a brief summary of possible forms of the disclosure. Indeed, the disclosure may encompass a variety of forms that may be similar to or different from the embodiments set forth below.

In an embodiment, an agricultural system includes a frame, a cutter bar assembly configured to cut crops during an operation of the agricultural system, and a reel configured to guide the crops toward the cutter bar assembly and to move relative to the frame during the operation of the agricultural system. The agricultural system also includes a controller configured to receive sensor feedback indicative of occurrences of the reel being in an undesirable position relative to the cutter bar assembly, receive additional sensor feedback indicative of positions of the reel during the occurrences, generate one or more boundaries for the reel based on the positions of the reel during the occurrences, and provide an output based on the one or more boundaries.

In an embodiment, an agricultural system includes a controller configured to receive sensor feedback indicative of occurrences of a reel being in an undesirable position relative to a cutter bar assembly, receive additional sensor feedback indicative of positions of the reel during the occurrences, and generate a plurality of boundaries for the reel based on the positions of the reel during the occurrences. The controller is also configured to instruct display of an indication of the plurality of boundaries on a display screen, receive an operator input indicative of a selection of a first boundary of the plurality of boundaries, and provide the output based on the first boundary of the one or more boundaries.

In an embodiment, a method of operating an agricultural system includes moving, using a controller, a reel relative to a frame during operation of the agricultural system. The method also includes receiving, at the controller, sensor feedback indicative of occurrences of the reel being in an undesirable position relative to a cutter bar assembly. The method also includes receiving, at the controller, additional sensor feedback indicative of positions of the reel during the occurrences. The method also includes generating, using the controller, one or more boundaries for the reel based on the positions of the reel during the occurrences. The method further includes providing, using the controller, an output based on the one or more boundaries.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a side view of an agricultural system, in accordance with an embodiment of the present disclosure;

FIG. 2 is a perspective view of a header that may be employed within the agricultural system of FIG. 1, in accordance with an embodiment of the present disclosure;

FIG. 3 is a cross-sectional side view of the header of FIG. 2, in accordance with an embodiment of the present disclosure;

FIG. 4 is a schematic side view of a portion of the header of FIG. 2 and a boundary for a reel of the header, in accordance with an embodiment of the present disclosure;

FIG. 5 is a schematic side view of a portion of the header of FIG. 2 with multiple data points associated with positions of the reel of the header, in accordance with an embodiment of the present disclosure;

FIG. 6 is a schematic side view of a portion of the header of FIG. 2 with multiple boundaries generated based on the multiple data points associated with the positions of the reel of the header, in accordance with an embodiment of the present disclosure;

FIG. 7 is a series of graphs that illustrate the multiple data points associated with the positions of the reel of the header and bins that facilitate generation of the multiple boundaries for the reel of the header, in accordance with an embodiment of the present disclosure;

FIG. 8 is a series of graphs that illustrate analysis of a column of bins to generate a boundary point of one of the multiple boundaries for the reel of the header, in accordance with an embodiment of the present disclosure;

FIG. 9 is a series of graphs that illustrate analysis of the bins to generate multiple boundary points of one of the multiple boundaries for the reel of the header, in accordance with an embodiment of the present disclosure;

FIG. 10 is a graphical user interface that may be provided via a display screen associated with the header of FIG. 2, in accordance with an embodiment of the present disclosure; and

FIG. 11 is a flowchart of a method for generating one or more boundaries for the reel of the header of FIG. 2, in accordance with an aspect of the present disclosure.

### DETAILED DESCRIPTION

One or more of the specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers'specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

The process of farming typically begins with planting seeds within a field. Over time, the seeds grow and eventually become harvestable crops. Often, only a portion of each crop is commercially valuable, so each crop is harvested to separate the usable material from the remainder of the crop. For example, a harvester may cut crops within a field via a header, which may include a flexible draper header. The header may include a cutter bar assembly configured to cut the crops. As the cutter bar assembly cuts the crops, a conveyor coupled to draper deck(s) of the header moves the cut crops toward a crop processing system of the harvester. For example, the conveyor on the side draper deck(s) may move the cut crops toward an infeed draper deck at a center of the header. A conveyor on the infeed draper deck may then move the cut crops toward the crop processing system. The crop processing system may include a threshing machine configured to thresh the cut crops, thereby separating the cut crops into certain desired agricultural materials, such as grain, and material other than grain (MOG). The desired agricultural materials may be sifted and then accumulated into a tank. When the tank fills to capacity, the desired agricultural materials may be collected from the tank. The MOG may be discarded from the harvester (e.g., via a spreader) by passing through an exit pipe or a spreader to fall down onto the field.

In some embodiments, portions of the cutter bar assembly may move so as to follow a contour of the field. For example, the cutter bar assembly may be flexible to remain in contact with the field during harvesting operations. Furthermore, the header of the harvester includes a reel (e.g., reel assembly) configured to prepare the crops to be cut by the cutter bar assembly. As an example, the reel may be positioned adjacent to the cutter bar assembly and may be configured to guide the crops toward the cutter bar assembly to facilitate cutting the crops. The position of the reel is adjustable relative to the cutter bar assembly so as to enable the reel to effectively guide the crops toward the cutter bar assembly. However, in some circumstances, the cutter bar assembly and the reel may interfere with one another. For instance, the cutter bar assembly may contact part of the reel, thereby limiting an effectiveness of the cutter bar assembly, the reel, and the header.

It is now recognized that limiting a position (e.g., lower position) of the reel to avoid contact with the cutter bar assembly may improve operation of the header. Therefore, the present disclosure is directed to generating one or more boundaries (e.g., lower boundaries) for the reel, and then providing one or more outputs based on the one or more boundaries. The one or more outputs may include a slow control signal to adjust (e.g., slow) movement of the reel below a set boundary (e.g., selected boundary) of the one or more boundaries, a block control signal to block movement of the reel below the set boundary of the one or more boundaries, and/or an alert (e.g., visible and/or audible alert) to an operator in response to an operator input that instructs movement of the reel below the set boundary of the one or more boundaries. Advantageously, the one or more boundaries may be established for each header (e.g., specific to each header) based on sensor feedback (e.g., sensor data) collected during operation of the header. Furthermore, multiple boundaries may be established for each header, wherein each boundary of the multiple boundaries is associated with a different risk level for contact between the reel and the cutter bar assembly.

For example, based on the sensor feedback collected during operation of the header, a controller (e.g., electronic controller; computing system) may establish a first boundary that corresponds to a higher risk of contact (e.g., 100 percent chance of contact during operation), a second boundary that corresponds to an intermediate risk of contact (e.g., 40 percent chance of contact during operation), and/or a third boundary that corresponds to a low risk of contact (e.g., 0 percent chance of contact during operation). The controller may instruct display of selectable icons (e.g., virtual buttons) that enable an operator to select the first, second, or third boundary based on a preference related to the risk level for contact between the reel and the cutter bar assembly. Different operators may have different preferences related to the risk level for any of a variety of reasons, such as related to field conditions, a type of crop being harvested, and/or tolerance for making repairs to the reel, for example.

In any case, after a particular boundary is set (e.g., selected) for the header, the operator may then adjust the reel to move (e.g., fore/aft and/or up/down) relative to the cutter bar assembly. For example, the operator may adjust the reel to move relative to the cutter bar assembly as the header travels through a field during a harvesting operation. However, the controller may block the reel from being moved across (e.g., below; toward the cutting bar assembly) the particular boundary that is set for the header. Additionally or alternatively, the controller may slow movement of the reel below the particular boundary that is set for the header (e.g., move the reel at a first, faster rate above the particular boundary and move the reel at a second, slower rate below the particular boundary; move the reel quickly to a set point above the particular boundary, move the reel slowly via small incremental steps toward the set point below the particular boundary until detection of a threshold distance), provide the alert to the operator in response to the operator input that instructs movement of the reel below the particular boundary that is set for the header, and/or provide other outputs based on the particular boundary that is set for the header.

It should be appreciated that the controller may instruct display of selectable icons (e.g., virtual buttons) that enable the operator to input preferences with respect to the outputs, such as preferences related to blocking downward movement of the reel, adjusting/slowing downward movement of the reel, and/or providing alerts. For example, the operator may prefer that the controller block the downward movement of the reel during some periods of time/passes through the field and slow the downward movement of the reel during other periods of times/passes through the field. However, in some embodiments, the controller may control these features, such as by blocking the downward movement of the reel during certain periods of time/passes through the field, but merely slowing the downward movement of the reel during certain periods of time/passes through the field. Providing at least some periods of time/passes through the field in which the downward movement of the reel to a set position that is below the set boundary is slowed (rather than blocked entirely) may enable collection of additional data points to maintain the one or more boundaries.

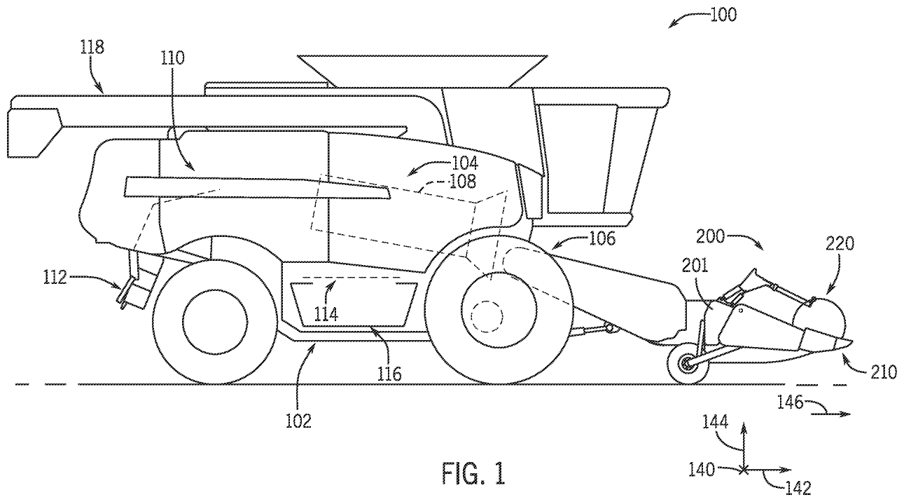

With the foregoing in mind, FIG. 1 is a side view of an embodiment of an agricultural system 100, which may be a harvester. The agricultural system 100 includes a chassis 102 configured to support a header 200 and an agricultural crop processing system 104. The header 200 is configured to cut crops and to transport the cut crops toward an inlet 106 of the agricultural crop processing system 104 for further processing of the cut crops.

The agricultural crop processing system 104 receives the cut crops from the header 200 and separates desired crop material from crop residue. For example, the agricultural crop processing system 104 may include a thresher 108 having a cylindrical threshing rotor that transports the cut crops in a helical flow path through the agricultural system 100. The thresher 108 may also separate the desired crop material (e.g., grain) from the crop residue (e.g., husks and pods), and the thresher 108 may enable the desired crop material to flow into a cleaning system 114 located beneath the thresher 108.

The cleaning system 114 may remove debris from the desired crop material and transport the desired crop material to a storage tank 116 within the agricultural system 100. When the storage tank 116 is full, a tractor with a trailer on the back may pull alongside the agricultural system 100. The desired crop material collected in the storage tank 116 may be carried up by an elevator and dumped out of an unloader 118 into the trailer. The crop residue may be transported from the thresher 108 to a crop residue handling system 110, which may process (e.g., chop/shred) and remove the crop residue from the agricultural system 100 via a crop residue spreading system 112 positioned at an aft end of the agricultural system 100. To facilitate discussion, the agricultural system 100 and/or its components may be described with reference to a lateral axis or direction 140, a longitudinal axis or direction 142, and a vertical axis or direction 144. The agricultural system 100 and/or its components may also be described with reference to a direction of travel 146 (e.g., forward direction of travel).

As discussed in detail below, the header 200 includes a cutter bar assembly 210 configured to cut the crops within the field. The header 200 also includes a reel 220 (e.g., reel assembly) configured to engage the crops to prepare the crops to be cut by the cutter bar assembly 210 and/or to urge the crops cut by the cutter bar assembly 210 onto a conveyor system that directs the cut crops toward the inlet 106 of the agricultural crop processing system 104. The reel 220 includes a reel member having multiple fingers (e.g., tines) extending from a central framework. The central framework is driven to rotate such that the fingers engage the crops and urge the crops toward the cutter bar assembly 210 and the conveyor system. Additionally, the reel members may be slidingly supported on multiple arms (e.g., reel arms) that are coupled to a frame 201 of the header 200. Furthermore, each of the arms may be coupled to the frame 201 via a respective pivot joint. For example, one pivot joint is configured to enable a first arm of the multiple arms to pivot (e.g., about the lateral axis 140) relative to the frame 201, and another pivot joint is configured to enable a second arm of the multiple arms to pivot (e.g., about the lateral axis 140) relative to the frame 201. It should be appreciated the header with the cutter bar assembly and the reel may be employed in any suitable type of harvester or similar machine (e.g., swathers/windrowers that gather the cut crops to form a windrow in the field that is later collected by the harvester).

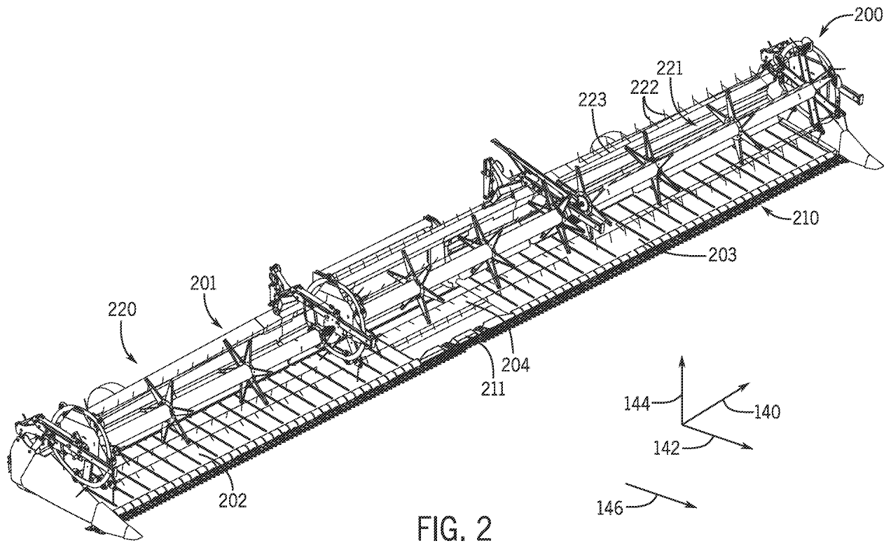

FIG. 2 is a perspective view of an embodiment of the header 200. In the illustrated embodiment, the header 200 includes the cutter bar assembly 210 configured to cut a portion of each crop (e.g., a stalk), thereby separating the crop from the soil. The cutter bar assembly 210 is positioned at a forward end of the header 200 relative to the longitudinal axis 142 of the header 200. As illustrated, the cutter bar assembly 210 extends along a substantial portion of the width of the header 200 (e.g., along the lateral axis 140).

The cutter bar assembly 210 includes a blade support, a stationary guard assembly, and a moving blade assembly. The moving blade assembly is fixed to the blade support (e.g., above the blade support along the vertical axis 144 of the header 200), and the blade support/moving blade assembly is driven to oscillate relative to the stationary guard assembly. The blade support/moving blade assembly may be driven to oscillate by a driving mechanism 211 positioned at a center of the header 200. However, in other embodiments, the blade support/moving blade assembly may be driven by another suitable mechanism (e.g., located at any suitable position on the header 200). As the agricultural system 100 is driven through the field, the cutter bar assembly 210 engages crops within the field, and the moving blade assembly cuts the crops (e.g., the stalks of the crops) in response to engagement of the cutter bar assembly 210 with the crops.

In the illustrated embodiment, the header 200 includes a first conveyor section 202 on a first lateral side of the header 200 and a second conveyor section 203 on a second lateral side of the header 200 opposite the first lateral side. The conveyor sections 202, 203 may be separate from one another. For instance, the first conveyor section 202 may extend along a portion of a width of the header 200 and the second conveyor section 203 may extend along another portion of the width of the header 200. Each conveyor section 202, 203 is driven to rotate by a suitable drive mechanism, such as an electric motor or a hydraulic motor. The first conveyor section 202 and the second conveyor section 203 are driven such that a top surface of each conveyor section 202, 203 moves laterally inward to a center conveyor section 204 positioned between the first conveyor section 202 and the second conveyor section 203 along the lateral axis 140. The center conveyor section 204 may also be driven to rotate by a suitable drive mechanism, such as an electric motor or a hydraulic motor. The center conveyor section 204 is driven such that the top surface of the center conveyor section 204 moves rearwardly relative to the direction of travel 146 toward the inlet. As a result, the conveyor sections 202, 203, 204 transport the cut crops through the inlet to the agricultural crop processing system for further processing of the cut crops. Although the illustrated header 200 includes two conveyor sections 202, 203 configured to direct crops toward the center conveyor section 204, there may be any suitable number of conveyor sections in additional or alternative embodiments directing the crops toward the center conveyor section.

The crops cut by the cutter bar assembly 210 are directed toward the conveyor sections 202, 203 at least in part by the reel 220, thereby substantially reducing the possibility of the cut crops falling onto the surface of the field. The reel 220 includes a reel member 221 (e.g., wheel) having multiple fingers or tines 222 extending from a central framework 223. The central framework 223 is driven to rotate such that the tines 222 move (e.g., in a circular pattern). The tines 222 are configured to engage the crops and urge the cut crops toward the conveyor sections 202, 203 to facilitate transport of the cut crops to the agricultural crop processing system.

In some embodiments, the frame 201 of the header 200 may be movably coupled to the chassis of the agricultural system. As illustrated herein, the cutter bar assembly 210 is flexible along the width of the header 200. In particular, the cutter bar assembly 210 is supported by multiple arm assemblies distributed along the width of the header 200. Each arm assembly is mounted to the frame 201 and includes an arm coupled to the cutter bar assembly 210. The arm may rotate and/or move the cutter bar assembly 210 along the vertical axis 144 relative to the frame 201, thereby enabling the cutter bar assembly 210 to flex during operation of the agricultural system. Thus, the cutter bar assembly 210 may follow the contours of the field, thereby enabling the cutting height (e.g., the height at which each crop is cut) to be substantially constant along the width of the header 200.

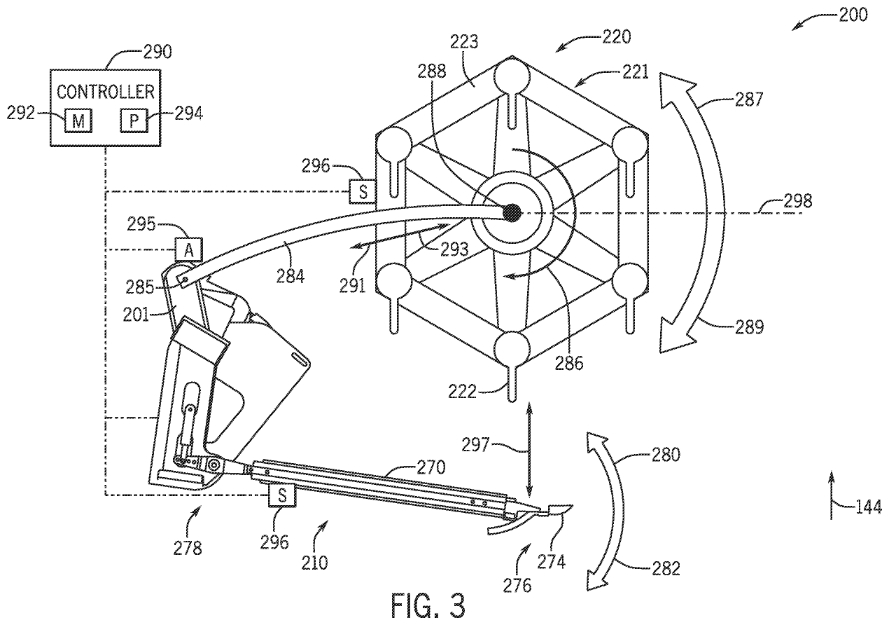

FIG. 3 is a cross-sectional side view of an embodiment of the header 200. The cutter bar assembly 210 includes arms 270 supporting blades 274 at a first end 276 of the arms 270. Further, the arms 270 may be coupled to the frame 201 of the header 200 at a second end 278 of the arms 270. As an example, the arms 270 may be pivotably coupled to the frame 201 at the second end 278. In this manner, the arms 270 may be configured to rotate relative to the frame 201. As such, the arms 270 may rotate in a first rotational direction 280 (e.g., upward), which may raise the arms 270 along the vertical axis 144, and the arms 270 may rotate in a second rotational direction 282 (e.g., downward), which may lower the arms 270 along the vertical axis 144.

In certain embodiments, the arms 270 may freely rotate in the rotational directions 280, 282 to follow a contour of the field. For example, the arms 270 may position the blades 274 to maintain contact with the field. As such, an upward slope of the field may push the arms 270 to rotate in the first rotational direction 280 to raise the blades 274 relative to the frame 201 and therefore avoid inserting the blades 274 into the field. Moreover, at a downward slope of the field, the weight of the blades 274 may cause the arms 270 to rotate in the second rotational direction 282 to lower the blades 274 relative to the frame 201 such that the blades 274 remain in contact with the field. In additional or alternative embodiments, the entire cutter bar assembly may translate along the vertical axis. That is, in addition to or as an alternative to rotating about the frame, the cutter bar assembly may slide along the frame in the vertical direction. Indeed, the cutter bar assembly 210 may be configured to move in any suitable manner relative to the frame 201 to enable the blades 274 to maintain contact with and/or to generally follow along contours of the field as the header 200 travels through the field.

The reel 220 may also move relative to the frame 201 and relative to the cutter bar assembly 210. In the illustrated embodiment, the frame 201 includes an extension 284 (e.g., a reel arm) that couples the reel member 221 (which includes the central framework 223 and the tines 222) to the frame 201. The extension 284 may position the reel member 221 above the cutter bar assembly 210 along the vertical axis 144 such that the reel 220 may urge the cut crops toward the blades 274. For instance, the reel member 221 may rotate in a third rotational direction 286 about a pivot point 288 that couples the reel member 221 to the extension 284. By rotating in the third rotational direction 286, the tines 222 may guide the crops toward the blades 274 that cut the crops.

The extension 284 may also move relative to the frame 201 to move the reel 220 relative to the frame 201 and relative to the cutter bar assembly 210. As an example, the extension 284 may rotate about a pivot point 285 that couples the extension 284 to the frame 201. Thus, the extension 284 may rotate about the frame 201 and may be configured to raise the reel 220 in a first rotational direction 287 (e.g., upward) relative to the vertical axis 144 and/or in a second rotational direction 289 relative to the vertical axis 144 (e.g., downward). In this way, the extension 284 may be positioned desirably relative to the cutter bar assembly 210 to enable the reel 220 to guide the crops to be cut by the cutter bar assembly 210. In an example, the reel 220 may be positioned proximate to the cutter bar assembly 210 without the tines 222 interfering (e.g., contacting) with the blades 274. The reel member 221 may also be configured to slide (e.g., fore/aft) relative to the extension 284. For example, the reel member 221 may slide in a rearward direction 291 and a forward direction 293 along the extension 284. In additional or alternative embodiments, the entire reel may translate along the vertical axis. That is, in addition to or as an alternative to rotating about the frame, the cutter bar assembly may slide along the frame in the vertical direction. Indeed, the reel may be configured to move in any suitable manner relative to the frame 201 to enable the tines 222 to capture and/or direct the crops as the header 200 travels through the field.

As shown, the header 200 includes and/or is communicatively coupled to a controller 290 (e.g., electronic controller; computing system) configured to perform calculations and/or control operating parameters of at least portions of the agricultural system, such as of the header 200. The controller 290 may include a memory 292 and a processor 294 (e.g., a microprocessor). The controller 290 may also include one or more storage devices and/or other suitable components. The processor 294 may be used to execute software, such as software for processing sensor feedback, generating one or more boundaries, and/or controlling the agricultural system and/or the header 200.

Moreover, the processor 294 may include multiple microprocessors, one or more “general-purpose” microprocessors, one or more special-purpose microprocessors, and/or one or more application specific integrated circuits (ASICS), or some combination thereof. For example, the processor 294 may include one or more reduced instruction set (RISC) or complex instruction set (CISC) processors. The memory 292 may include a volatile memory, such as random access memory (RAM), and/or a nonvolatile memory, such as read-only memory (ROM). The memory 292 may store a variety of information and may be used for various purposes. For example, the memory 292 may store processor-executable instructions (e.g., firmware or software) for the processor 294 to execute, such as instructions for processing sensor feedback, generating the one or more boundaries, and/or controlling the agricultural system and/or the header 200. The memory 292 and/or the processor 294, or an additional memory and/or processor, may be located in any suitable portion of the agricultural system. By way of example, the controller 290 may be located in a cab of the agricultural system and/or on the header 200.

As shown, the header 200 may include one or more actuators 295 and one or more sensors 296. The one or more actuators 295 may be configured to move the extension 284 relative to the frame 201 to move the reel 220 up and down relative to the frame 201 and relative to the cutter bar assembly 210. The one or more actuators 295 may also be configured to move the reel member 221 fore and aft along the extension 284 to move the reel member 221 relative to the frame 201 and relative to the cutter bar assembly 210.

The sensors 296 may be disposed on the cutter bar assembly 210, on the reel 220, and/or any other suitable location of the header 200. Although two sensors 296 are shown to represent a presence of the sensors 296 on the cutter bar assembly 210 and/or on the reel 220, it should be appreciated that any number of sensors 296 may be placed at any of a variety of locations (e.g., proximate the first end 276 of the cutter bar assembly 210; proximate to a base of each tine 222). In any case, the sensors 296 may be configured to detect the respective positions of the cutter bar assembly 210 (e.g., a rotational position about the frame 201) and of the reel 220 (e.g., a rotational position about the frame 201 and/or a longitudinal position relative to the frame 201). As used herein, the position of the reel 220 may refer to a position of the pivot point 288 relative to the frame 201.

The sensors 296 may also be configured to detect the relative positions of the cutter bar assembly 210 and the reel 220 (e.g., a distance between the cutter bar assembly 210 and the reel 220). In particular, the sensors 296 may be configured to detect when the reel 220 (e.g., the tines 222) are in an undesirable position relative to the cutter bar assembly 210 (e.g., within a threshold distance 297 of the cutter bar assembly 210, which may refer to being in proximity of the cutter bar assembly 210 and/or in contact with the cutter bar assembly 210). While the threshold distance 297 is illustrated between the cutter bar assembly 210 and the tines 222 of the reel 220 to facilitate discussion, it should be appreciated that the threshold distance 297 may be measured between any suitable portions of the cutter bar assembly 210 and the reel 220.

In some embodiments, each time the reel 220 is within the threshold distance 297 of the cutter bar assembly 210, the controller 290 may respond by controlling the one or more actuators 295 to move the reel 220 away from the cutter bar assembly 210 (e.g., to move the reel 220 in the first rotational direction 287). In some embodiments, the threshold distance 297 may essentially be zero, such that the sensors 296 detect when the reel 220 contacts the cutter bar assembly 210. In such cases, each time the reel 220 contacts the cutter bar assembly 210, the controller 290 may respond by controlling the one or more actuators 295 to move the reel 220 away from the cutter bar assembly 210 (e.g., to pivot to move the reel 220 in the first rotational direction 287). It should be appreciated that the sensors 296 may include position sensors, proximity sensors, electromagnetic sensors, reed switch sensors, hall effect sensors, optical sensors, contact sensors, or any suitable type of sensors.

Thus, the controller 290 may receive the sensor feedback that indicates the position of the reel 220 relative to the frame 201, as well as each occurrence of the reel 220 being within the threshold distance 297 of the cutter bar assembly 210. Accordingly, the controller 290 may track the position of the reel 220 relative to the frame 201 at each occurrence of the reel 220 being within the threshold distance 297 of the cutter bar assembly 210. As discussed in more detail herein, the sensor feedback (e.g., sensor data) may enable the controller 290 to generate one or more boundaries for the reel 220 of the header 200.

Furthermore, the controller 290 may utilize the one or more boundaries to block or to limit movement of the reel 220 of the header 200. In some embodiments, the controller 290 may include or be communicatively coupled to a user interface, which may be used by the operator to provide user inputs to position the cutter bar assembly 210 and/or the reel 220. In this manner, the controller 290 may enable the operator to adjust the reel 220 to a desired position, such as based on the type of crops being harvested by the header 200, the contour of the field being harvested by the header 200, and so forth. The controller 290 may be configured to enable movement of the reel 220 on one side (e.g., above; opposite the cutter bar assembly 210) of a set boundary of the one or more boundaries. However, the controller 290 may be configured to block or to limit movement of the reel 220 from being positioned across (e.g., below; toward the cutter bar assembly 210) the set boundary of the one or more boundaries. The controller 290 may also provide an alert (e.g., audio and/or visual alert) to the operator in response to receipt of an operator input to move reel 220 below the set boundary of the one or more boundaries. In some cases, the controller 290 may enable the operator to select a particular boundary as the set boundary of the one or more boundaries (e.g., based on a preference related to a risk of contact between the reel 220 and the cutter bar assembly 210). In this way, a likelihood of the reel 220 contacting the cutter bar assembly 210 may be limited and/or set according to the preference of the operator.

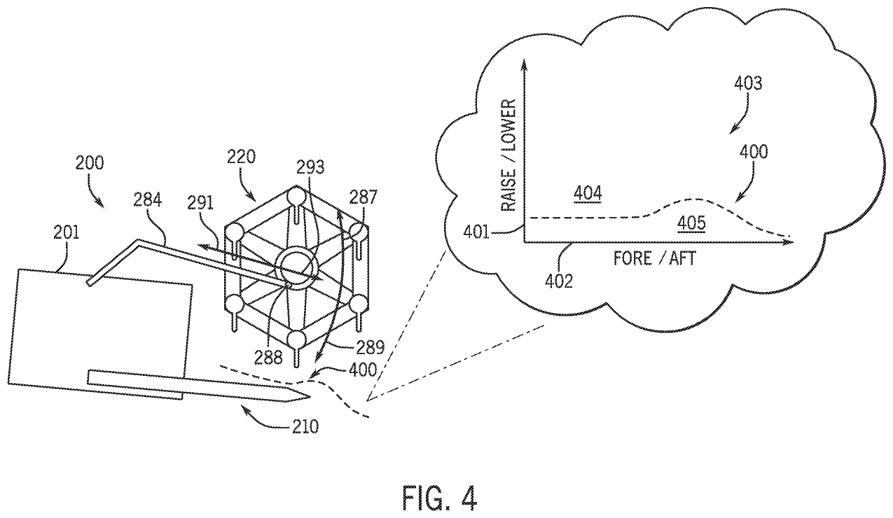

FIG. 4 is a schematic view of a portion of the header 200 with an example of a boundary 400 that may be generated for the reel 220 of the header 200. As shown, the boundary 400 is multi-dimensional (e.g., two-dimensional) and may be defined with respect to a raise/lower axis 401 and a fore/aft axis 402. As shown, the raise/lower axis 401 and the fore/aft axis 402 may be represented along a y-axis and a x-axis, respectively, in a graph 403. As set forth herein, the controller may be configured to enable movement of the reel 220 on an upper side 404 (e.g., above; opposite the cutter bar assembly 210) of the boundary 400 and to block the reel 220 from being positioned on a lower side 405 (e.g., below; toward the cutter bar assembly 210) the boundary 400. The controller may block the reel 220 from being positioned on the lower side 405 simply by blocking certain movements of the reel 220 (e.g., downward); however, it should be appreciated that this may also be accomplished by initiating certain movements of the reel 220 (e.g., upward). In some cases, the controller may be configured to limit (e.g., slow; small increments) movement of the reel 220 on the lower side 405 of the boundary 400.

Thus, the operator may provide inputs via the user interface to adjust the reel 220 in the first rotational direction 287 (e.g., upward) and/or in the second rotational direction 289 (e.g., downward), as well as in in the rearward direction 291 and the forward direction 293 along the extension 284. The controller may monitor (e.g., via the sensor feedback) the position of the pivot point 288 to guide and/or to limit the movement of the reel 220 with respect to the boundary 400; however, it should be appreciated that the controller may monitor the respective position of any portion of the reel 220 to guide and/or to limit the movement of the reel 220 with respect to the boundary 400.

In some embodiments, the boundary 400 may be provided as a default boundary (e.g., set at manufacturing). The default boundary may be implemented in multiple different headers of the same or similar type/construction. However, it is presently recognized that it may be desirable to only utilize the default boundary during an initial time period of use of the header 200 (or during limited time periods, such as at the beginning of each new harvesting season or after a full reset of the header 200). For example, the controller may only utilize the default boundary during a first pass(es) through the field, and the controller may update the default boundary to generate a machine-specific (e.g., header-specific; unique) boundary for the header 200. Such techniques provide various advantages, such as a reduction in a number of default boundaries that are generated and stored on headers 200 at manufacturing, as well as an ability to adapt to and account for manufacturing variations between different headers, field conditions, and the like. It should be appreciated that the default boundary may be established based on modeled data, empirical data from multiple other headers, and/or header-specific data collected during trial operation of the header 200 in a field or manufacturing facility. The default boundary may have a shape similar to the boundary 400 shown in FIG. 4, although the shape may vary based on a configuration of the header.

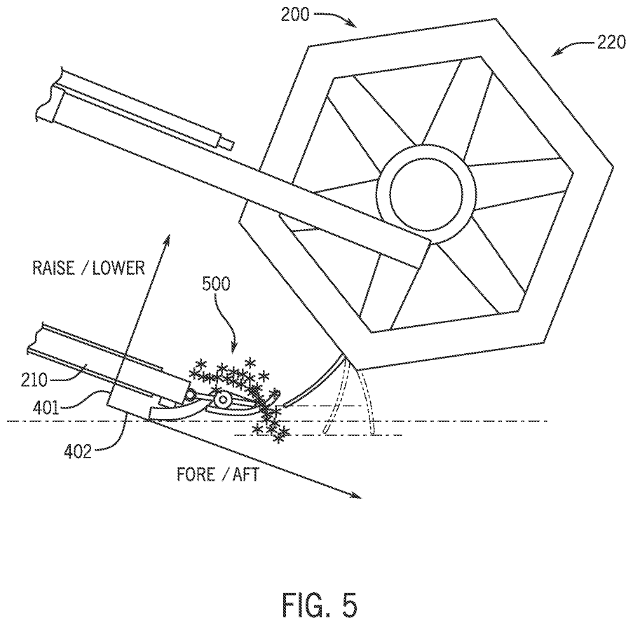

FIG. 5 is a schematic view of a portion of the header 200 with multiple data points 500 associated with positions of the reel 220 of the header 200. As noted herein, the sensors on the reel 220 and/or the cutter bar assembly 210 may provide the sensor feedback to the controller. The sensor feedback indicates the position of the reel 220 relative to the frame of the header 200 during each occurrence of the reel 220 being within the threshold distance of the cutter bar assembly 210 (e.g., due to the cutter bar assembly 210 pivoting/flexing as the header 200 travels across the field). In this way, the controller may track the position of the reel 220 relative to the frame during each occurrence of the reel 220 being within the threshold distance of the cutter bar assembly 210.

Accordingly, the controller may plot the data points 500 with respect to the raise/lower axis 401 and the fore/aft axis 402, wherein each data point 500 represents the position of the reel 220 (e.g., along the raise/lower axis 401 and the fore/aft axis 402) at a respective occurrence of the reel 220 being within the threshold distance of the cutter bar assembly 210. As discussed in more detail herein, the controller may analyze the data points 500 to generate one or more boundaries (e.g., header-specific boundaries) for the reel 220 of the header 200.

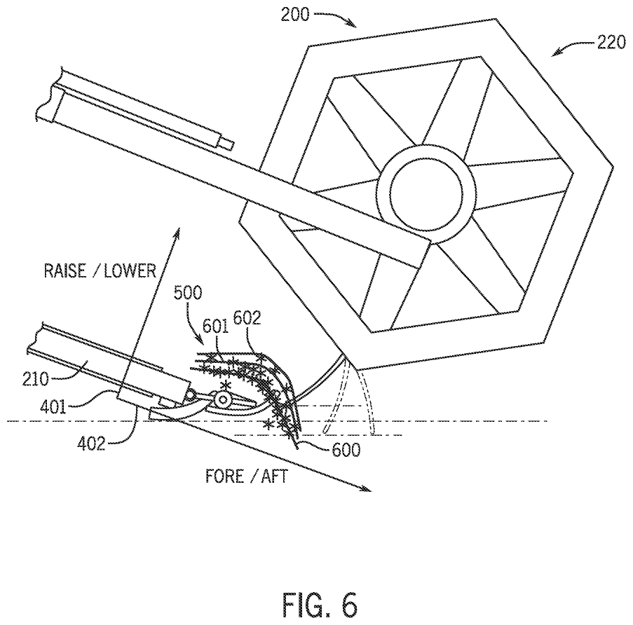

FIG. 6 is a schematic view of a portion of the header 200 with multiple boundaries generated based on the data points 500. In particular, FIG. 6 includes a first boundary 600 (e.g., high-risk boundary), a second boundary 601 (e.g., intermediate-risk boundary), and a third boundary 602 (e.g., low-risk boundary). However, it should be appreciated that the controller may generate any suitable number (e.g., 1, 2, 3, 4, 5, 6, or more) of boundaries for the header 200.

In any case, each of the multiple boundaries is associated with a different risk level for contact between the reel 220 and the cutter bar assembly 210 as the header 200 travels through the field. For example, the first boundary 600 has a high risk level for contact between the reel 220 and the cutter bar assembly 210, the second boundary 601 has an intermediate risk level for contact between the reel 220 and the cutter bar assembly 210, and the third boundary has a low risk level for contact between the reel 220 and the cutter bar assembly 210. In some embodiments, the low risk level may be associated with a zero percent chance of contact, the intermediate risk level may be associated with a 40 percent chance of contact, and the high risk level may be associated with a 100 percent chance of contact.

However, it should be appreciated that each risk level may represent any of suitable chance of contact. For example, the low risk level may be associated with less than or equal to about 0, 10, 20, 30, 40, or 50 percent chance of contact; the intermediate risk level may be associated with about 30, 40, 50, 60, or 70 percent chance of contact; the high risk level may be associated with greater than or equal to about 50, 60, 70, 80, 90, or 100 percent chance of contact. Indeed, the controller may establish any number of boundaries with varied (e.g., stepped; different) estimated chances of contact during harvesting operations may be employed in the header 200. The risk levels and the estimated chances of contact during the harvesting operations may be estimated and/or calculated in any suitable manner, such as based on the sensor feedback that indicates a percentage of times that a particular position of the reel 220 (e.g., along the up/down axis 401 and the fore/aft axis 402) has resulted in the reel 220 being within the threshold distance of the cutter bar assembly 210. As another example, the risk levels and the estimated chances of contact during harvesting operations may be estimated and/or calculated based on the sensor feedback that indicates certain positions of the reel 220 that result in zero occurrences of the reel 220 being within the threshold distance of the cutter bar assembly 210, certain other positions of the reel 220 result in continuous (or frequent) occurrences of the reel 220 being within the threshold distance of the cutter bar assembly, and positions therebetween (e.g., midpoints) for the reel 220 therefore result in some intermediate risk level. It should be appreciated that the risk level may represent the chance of contact and/or the chance of the reel 220 being within the threshold distance of the cutter bar assembly 210 (e.g., 40 percent chance of contact or 40 percent chance of the reel 220 being within the threshold distance of the cutter bar assembly 210). Additionally, the output may vary based on a respective risk level of a set boundary. For example, the controller may block the reel 220 from being positioned below the first boundary 600 with the high risk level (e.g., hard boundary). However, the controller may limit (e.g., slow) movement of the reel 220 between the third boundary 602 with the low risk level and the high risk level (e.g., soft boundary). In some embodiments, the controller may provide the alert, while also permitting movement of the reel 220 between the third boundary 602 with the low risk level and the high risk level.

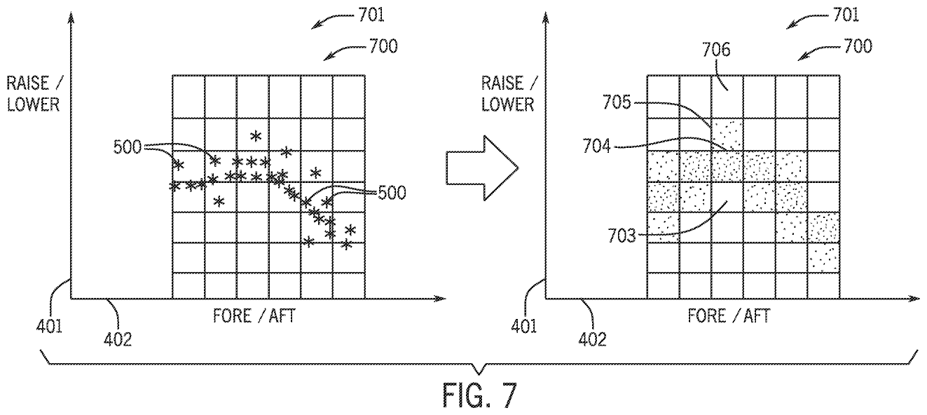

FIGS. 7-9 illustrate various processing steps that may be carried out by the controller to generate one or more boundaries, such as the multiple boundaries of FIG. 6. In particular, FIG. 7 is a series of graphs that illustrate the data points 500 associated with the position of the reel of the header and bins 700 generated to facilitate formation of the one or more boundaries for the reel of the header. In particular, the data points 500 are plotted with respect to the raise/lower axis 401 and the fore/aft axis 402 in a graph 701. The bins 700 (e.g., a grid that defines the bins 700) are overlaid onto the graph 701, and a map 702 (e.g., heat map) is generated based on a presence of data points 500 in each of the bins 700. Because the bins 700 correspond to various positions of the reel 220, analysis of the data points 500 in each of the bins 700 may be utilized to establish the one or more boundaries for the header 200.

For example, a series of bins (e.g., column of bins) defined at a particular location along the fore/aft axis 402 may include a first bin 703 at a first vertical position (e.g., lower), a second bin 704 at a second vertical position (e.g., intermediate), a third bin 705 at a third vertical position (e.g., higher), and a fourth bin 706 at a fourth vertical position (e.g., highest). As shown, the first bin 703 and the fourth bin 706 do not include any data points 500; however, the second bin 704 includes multiple data points 500 (e.g., a highest number of data points 500 among all bins in the series of bins defined at the particular fore/aft axis 402), and the third bin 705 includes a single data point 500. Thus, in this series of bins, the third boundary with the low-risk level (e.g., zero percent chance of contact) may be determined to have a respective boundary point that corresponds to an upper edge of the third bin 705, the first boundary with the high-risk level (e.g., 100 percent chance of contact) may be determined to have a respective boundary point that corresponds to a lower edge of the second bin 704, and the second boundary with the intermediate-risk level (e.g., 40 percent chance of contact) may be determined to have a respective boundary point located between the upper edge of the third bin 705 and the lower edge of the second bin 704 (all with respect to the raise/lower axis 401). Similar processing steps may be carried out with respect to each series of bins (e.g., each column of bins) at various locations along the fore/aft axis 402 to create the multiple boundary points that are defined with respect to the raise/lower axis 401 and the fore/aft axis 402 (e.g., multi-dimensional boundaries). It should also be appreciated that the controller may utilize any of a variety of algorithms to determine the multiple boundaries based on the data points 500.

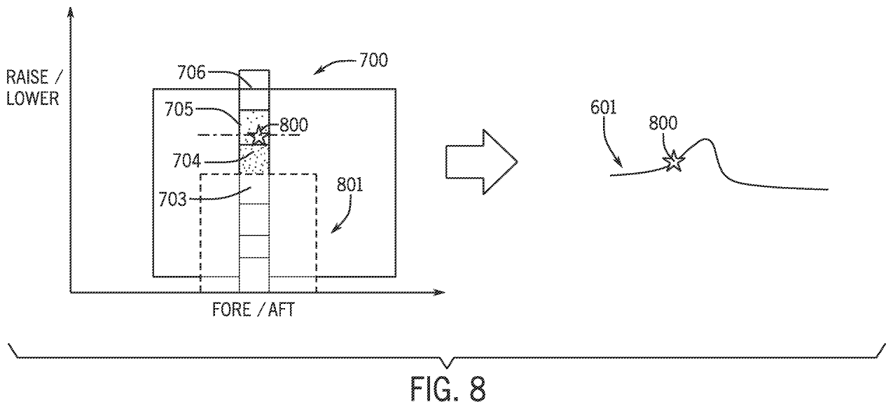

FIG. 8 is a series of graphs that illustrate a process for setting the one or more boundaries based on the series of bins identified in FIG. 7. As shown, the series of bins includes the first bin 703, the second bin 704, the third bin 705, and the fourth bin 706. A boundary point 800 may be identified (e.g., located between the upper edge of the third bin 705 and the lower edge of the second bin 704) and used to define the second boundary 601 with the intermediate-risk level (e.g., 40 percent chance of contact). As shown, a bin group 801 in the series of bins may not be of interest because the bin group 801 is closer to the cutter bar assembly than the first boundary with the high risk level.

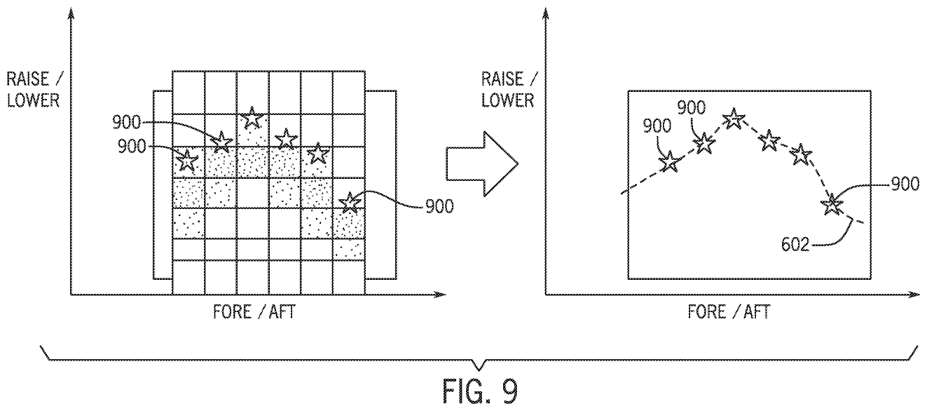

FIG. 9 is a series of graphs that illustrate the bins 700 and identification of one of the one or more boundaries, such as the third or low-risk boundary 602, for the reel of the header. In order to generate the exemplary boundary 602, each series of bins may be analyzed as described above with respect to FIGS. 7 and 8. For example, respective boundary points 900 are identified for each of the series of bins, and then the respective boundary points 900 are connected (e.g., via best fit line) to generate the exemplary boundary 602. Additional boundaries, such as the first or high-risk boundary and/or the second or intermediate-risk boundary, may be generated by identifying and connecting corresponding boundary points across the series of bins.

The controller may be configured to update the one or more boundaries over time, such as in response to each new occurrence of the reel being within the threshold distance of the cutter bar assembly, in real-time as the header travels through the field, at an end of a harvesting operation (e.g., during a shut down process in response to receipt of an operator input to turn off the header), at a start of a harvesting operation (e.g., during a turn on process in response to receipt of an operator input to turn on the header), upon request by the operator (e.g., in response to an operator input), and/or periodically (e.g., weekly, monthly, yearly).

In some embodiments, for each new occurrence of the reel being within the threshold distance of the cutter bar assembly, the controller may update an appropriate series of bins. That is, instead of storing a large number of raw data points, the controller may store indications of a distribution of the data points within each series of bins. Then, in response to receipt of a new data point that indicates that the reel at a particular position was within the threshold distance of the cutter bar assembly, the controller identifies a corresponding series of bins (e.g., along the fore/aft axis) and shifts the boundary point(s) within the corresponding series of bins. Such processing steps may provide efficient calculation and updates to the one or more boundaries, as well as reduce storage requirements in the controller.

It should be appreciated that the techniques disclosed herein may account for variations in position of the tines. For example, the tines of the reel may be configured to move relative to the reel member, such as from a first angle with respect to the reel member to a second angle with respect to the reel member. In any case, the data points may be collected across the various positions of the tines, which enables the boundaries to be used effectively regardless of the positions of the tines. In some embodiments, the controller may be configured to receive the position of the tines as an input and generate separate boundaries for each position of the tines (e.g., respective first, second, and third boundaries that are generated, accessed, and utilized when the tines are at the first angle; respective first, second and third boundaries that are generated, accessed, and utilized when the tines are at the second angle; and so on). In some embodiments, the header may be configured to operate in a flexible mode and a rigid mode at different times (e.g., selectable by the operator). In some cases, the multiple boundaries may be particularly helpful while the cutter bar assembly is in the flexible mode. However, different boundaries may be established for use the flexible mode and the rigid mode according to the techniques disclosed herein. Additionally, in some cases, one or more rigid mode default boundaries (e.g., set at manufacturing) may be used while the cutter bar assembly is in the rigid mode, and the one or more rigid mode default boundaries may not be updated during operation of the header..

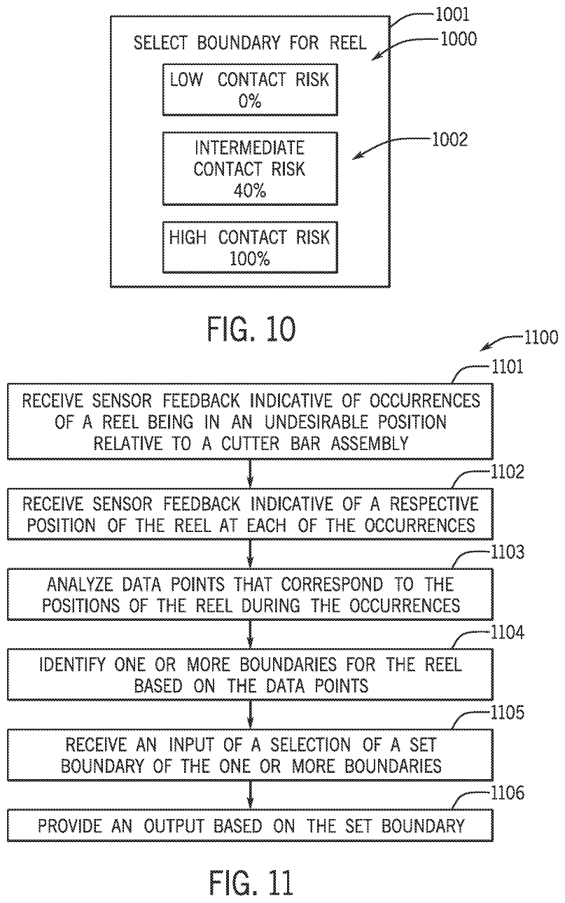

FIG. 10 is an example of a graphical user interface 1000 that may be presented on a display screen 1001 of the agricultural system of FIG. 1. As noted above, one or more boundaries may be established for the header, wherein each boundary of the one or more boundaries is associated with a different risk level for contact between the reel and the cutter bar assembly.

For example, based on the sensor feedback collected during operation of the header, the controller may establish the first boundary that corresponds to a higher risk of contact (e.g., 100 percent chance of contact), the second boundary that corresponds to an intermediate risk of contact (e.g., 40 percent chance of contact), and/or the third boundary that corresponds to a low risk of contact (e.g., 0 percent chance of contact). The controller may instruct display of selectable icons 1002 (e.g., virtual buttons) that enable an operator to select the first, second, or third boundary based on a preference related to the risk level for contact between the reel and the cutter bar assembly.

Accordingly, the techniques disclosed herein provide an adaptive boundary that is specific to the header, wherein the adaptive boundary updates over time (e.g., periodically, such as daily; after each user of the header). The techniques disclosed herein also convey the different boundary options to the operator in a manner that enables the operator to understand possible consequences of their selection, such as that selection of the lower boundary (e.g., the high contact boundary) has a high likelihood (e.g., 100 percent chance) of resulting in contact between the reel and the cutter bar assembly as the header travels through the field during harvesting operations. Certain operators may still choose to select the lower boundary in certain situations, such as when the crop is a high-value crop that is difficult to harvest without this close positioning of the reel and the cutter bar assembly.

In some embodiments, the controller may instruct output of an indication on the display screen 1001 to alert the operator in response to receipt of an input (e.g., from the operator) that commands the reel to move below the set boundary. The controller may enable the operator to confirm the input and, in response to the confirmation, the controller may then instruct the reel to move below the set boundary. In this way, the operator may be alerted and provide instructions to override the set boundary. It should be appreciated that any of a variety of other information may be provided on the display screen, such as the data points, any of the graphs provided herein, selectable icons to designate to block the downward movement of the reel below the set boundary, limit the downward movement of the reel below the set boundary, provide alerts, require confirmation prior to the downward movement below the set boundary, or the like.

FIG. 11 is a flowchart of an embodiment of a method 1100 for generating one or more boundaries for a reel of a header. The flowchart includes various steps represented by blocks. Although the flowchart illustrates the steps in a certain sequence, it should be understood that the steps may be performed in any suitable order and certain steps may be carried out simultaneously, where appropriate. Further, certain steps may be omitted and/or other steps may be added. While certain steps are described as being performed by a controller, it should be understood that the steps or portions thereof may be performed by any suitable processing device.

In step 1101, a controller may receive sensor feedback indicative of occurrences of a reel being within a threshold distance of a cutter bar assembly. The one or more sensors may be disposed on the reel and/or the cutter bar assembly. In some embodiments, each time the reel is within the threshold distance of the cutter bar assembly, the controller may respond by controlling the one or more actuators to move the reel (e.g., to pivot to move the reel in the first direction). In some embodiments, the threshold distance may essentially be zero, such that the sensors detect when the reel contacts the cutter bar assembly.

In step 1102, the controller may receive sensor feedback indicative of a respective position of the reel at each of the occurrences. The one or more sensors may be configured to detect the respective positions of the cutter bar assembly (e.g., a rotational position about the frame) and/or of the reel (e.g., a rotational position about the frame and/or a longitudinal position relative to the frame). Thus, the controller may receive the sensor feedback that indicates the position of the reel relative to the frame. Accordingly, the controller may track the position of the reel relative to the frame at each occurrence of the reel being within the threshold distance of the cutter bar assembly.

In step 1103, the controller may analyze data points that correspond to the positions of the reel during the occurrences. In particular, each data point represents the position of the reel (e.g., along the up/down axis and the fore/aft axis) at a respective occurrence of the reel being within the threshold distance of the cutter bar assembly.

In step 1104, the controller may identify one or more boundaries for the reel based on the data points. For example, the data points may be plotted with respect to the up/down axis and the fore/aft axis in a graph. Bins (e.g., a grid that defines the bins) are overlaid onto the graph, and a map (e.g., heat map) is generated based on a presence of data points in each of the bins. Because each of the bins corresponds to various positions of the reel, analysis of the data points in each of the bins may be utilized to establish the one or more boundaries for the header.

In step 1105, the controller may receive an input (e.g., from the operator) of a selection of a set boundary of the one or more boundaries. For example, the controller may instruct display of selectable icons (e.g., virtual buttons) that enable the operator to provide the input of the selection of the set boundary based on a preference related to a risk level for contact between the reel and the cutter bar assembly.

In step 1106, the controller may provide an output based on the set boundary. For example, the controller may block downward movement of the reel across the set boundary and/or slow downward movement of the reel below the set boundary during harvesting operations. Additionally or alternatively, the controller may provide an alert via a display screen to notify the operator that an instructed command for the reel would cause the reel to move across the set boundary.

As discussed herein, a sensor assembly may be utilized with the header (e.g., to generate the data points that are analyzed to establish the one or more boundaries), in accordance with embodiments of the present disclosure. The sensor assembly may include magnetic sensors that are configured to detect a magnet. In some embodiments, a series of multiple magnetic sensors may be coupled to the cutter bar assembly (e.g., extend long the lateral axis) to detect one or more magnets that are coupled to the reel. For example, a magnet may be coupled to one of the tines (e.g., embedded near a tip).

In some embodiments, the sensor assembly may include a transmitter/emitter pair on the cutter bar assembly and the reel, an optical and/or radar sensor on the reel, and/or one or more metal sensors (e.g., shown as antennas) that are configured to generate a magnetic field that is affected/skewed by a metal object, such as metal tines, a metal tine bar that supports the tines, a metal knife edge or other component of the cutter bar assembly, and/or metal coupled to (e.g., embedded) in the reel or cutter bar assembly. In some embodiments, the sensor assembly may include a capacitance sensor, a transmitter/emitter pair that communicate via radiofrequency communications, a radiofrequency identification (RFID) tag and a RFID scanner, and/or an ultrasonic sensor. It should be appreciated that any of the sensor assemblies may be configured to monitor and to provide the sensor feedback that is indicative of the position of the reel relative to the cutter bar assembly (e.g., whether the reel is in the undesirable position relative to the cutter bar assembly; in proximity and/or in contact with the cutter bar assembly; within the threshold distance). Furthermore, variations in the sensor assemblies are envisioned (e.g., the ultrasonic sensor on the reel or configured with a transmitter on one component and a receiver on another component). Indeed, any sensor component may be positioned on the cutter bar assembly or the on the reel.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function) . . . ” or “step for (perform)ing (a function) . . . ”, it is intended that such elements are to be interpreted under 35 U.S.C. 112(f). However, for any claims containing elements designated in any other manner, it is intended that such elements are not to be interpreted under 35 U.S.C. 112(f).

1. An agricultural system, comprising:
a frame;
a cutter bar assembly configured to cut crops during an operation of the agricultural system;
a reel configured to guide the crops toward the cutter bar assembly and to move relative to the frame during the operation of the agricultural system; and
a controller configured to:
receive sensor feedback indicative of occurrences of the reel being in an undesirable position relative to the cutter bar assembly;
receive additional sensor feedback indicative of positions of the reel during the occurrences;
generate one or more boundaries for the reel based on the positions of the reel during the occurrences; and
provide an output based on the one or more boundaries.

2. The agricultural system of claim 1, wherein the controller is configured to plot a plurality of data points along an up/down axis and a fore/aft axis, and the plurality of data points represent the positions of the reel during the occurrences.

3. The agricultural system of claim 2, wherein the controller is configured to overlay a grid of bins onto the plurality of data points, isolate a column of bins within the grid of bins, and define a first boundary point based on a distribution of the plurality of data points within the column of bins.

4. The agricultural system of claim 1, wherein the one or more boundaries comprise a plurality of boundaries that are each associated with a respective risk level of the reel being in the undesirable position relative to the cutter bar assembly.

5. The agricultural system of claim 4, wherein the plurality of boundaries comprise a first boundary with a first risk level that corresponds to a zero percent chance of the reel being in the undesirable position relative to the cutter bar assembly and a second boundary with a second risk level that is greater than the first risk level.

6. The agricultural system of claim 4, wherein the plurality of boundaries comprise at least three different boundaries.

7. The agricultural system of claim 1, wherein the one or more boundaries are multi-dimensional boundaries.

8. The agricultural system of claim 1, wherein the output comprises blocking the reel from moving across a set boundary of the one or more boundaries toward the cutter bar assembly during the operation of the agricultural system.

9. The agricultural system of claim 1, wherein the output comprises adjusting a rate of downward movement of the reel while the reel is positioned below a set boundary of the one or more boundaries relative to the cutter bar assembly during the operation of the agricultural system.

10. The agricultural system of claim 1, wherein the controller is configured to instruct display of an indication of the one or more boundaries on a display screen.

11. The agricultural system of claim 1, wherein the controller is configured to:
receive an operator input indicative of a selection of one boundary of the one or more boundaries; and
provide the output based on the one boundary of the one or more boundaries.

12. An agricultural system, comprising:
a controller configured to:
receive sensor feedback indicative of occurrences of a reel being in an undesirable position relative to a cutter bar assembly;
receive additional sensor feedback indicative of positions of the reel during the occurrences;
generate a plurality of boundaries for the reel based on the positions of the reel during the occurrences;
instruct display of an indication of the plurality of boundaries on a display screen;
receive an operator input indicative of a selection of a first boundary of the plurality of boundaries; and
provide the output based on the first boundary of the one or more boundaries.

13. The agricultural system of claim 12, wherein the controller is configured to:
assign a respective risk level of the reel being within the threshold distance of the cutter bar assembly to each of the plurality of boundaries; and
instruct display of the indication in a manner that conveys the respective risk level for each of the plurality of boundaries.

14. The agricultural system of claim 12, wherein the plurality of boundaries comprise the first boundary with a first risk level that corresponds to a zero percent chance of the reel being within the threshold distance of the cutter bar assembly and a second boundary with a second risk level that is greater than the first risk level.

15. The agricultural system of claim 12, wherein the plurality of boundaries comprise at least three different boundaries.

16. The agricultural system of claim 12, wherein the plurality of boundaries are multi-dimensional boundaries.

17. A method of operating an agricultural system, comprising:
moving, using a controller, a reel relative to a frame during operation of the agricultural system;
receiving, at the controller, sensor feedback indicative of occurrences of the reel being in an undesirable position relative to a cutter bar assembly;
receiving, at the controller, additional sensor feedback indicative of positions of the reel during the occurrences;
generating, using the controller, one or more boundaries for the reel based on the positions of the reel during the occurrences; and
providing, using the controller, an output based on the one or more boundaries.

18. The method of claim 17, comprising assigning, using the controller, a respective risk level of the reel being in the undesirable position relative to the cutter bar assembly to each of the one or more boundaries.

19. The method of claim 17, comprising blocking, using the controller, the reel from moving across the one or more boundaries toward the cutter bar assembly during the operation of the agricultural system.

20. The method of claim 17, comprising:
receiving, at the controller, an operator input indicative of a selection of one boundary of the one or more boundaries; and
providing, using the controller, the output based on the one boundary of the one or more boundaries.
